(19) United States
(12) Patent Application Publication
(10) Pub. No.: US 2005/0100018 A1
(43) Pub. Date: May 12, 2005

(54) Tag-based commands for controlling a set of receivers

(76) Inventors: Joseph L. Kennedy, Lawrenceville, GA (US); David M. Placek, Duluth, GA (US)

Correspondence Address: HUSCH & EPPENBERGER, LLC, 190 CARONDELET PLAZA, SUITE 600, ST. LOUIS, MO, 63105-3441, US

(21) Appl. No.: 10/702,703

(22) Filed: Nov. 6, 2003

(51) Int. Cl. H04L 12/56

(52) U.S. Cl. 370/395.2; 370/395.3

(57) ABSTRACT

This invention is a system and method for controlling a set of receivers in a distributed network. The system uses a tag-based syntax that defines the devices in the receivers and the corresponding commands for the respective devices. The tag is a combination of device and command constructs which is unique to each one of the receiver's parameters. The parameters can be logically grouped in a command stream using the device values. Members in the group are represented by the command values. The standardized syntax allows multiple parameters to be controlled with a single autonomous variable length command and also allows the receivers to operate on the command stream with a standardized set of parser routines.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to controlling a set of receivers and, more particularly, to tag-based commands for controlling the set of receivers in a distributed network.

2. Related Art

A known satellite point to multi-point network is illustrated in FIG. 1, wherein the point is referred to as the uplink and the multi-points are called downlinks with the equipment at each downlink referred to as a remote, including a remote receiver. In the satellite control network 10, control information is generated at the uplink 12 and transmitted via the satellite 14 to the downlinks 16. Control information is preferably generated at the uplink 12 by a control computer 18, fed to various conditioning and modulation circuits 20 and combined with other media signals in a combiner 22. These media signals may be video and/or audio fed to the combiner 22 through a modulator 24. These combined signals are sent by a transmitter 26 to a particular satellite 14 on a particular frequency. The transmitted signal is retransmitted by the satellite 14 back to locations within a particular geographic footprint area. The remote receivers use appropriate antennae and addressable logic to receive the transmitted signals and determine whether they are an intended recipient, respectively.

Controlling receivers over transmission systems have, in the past, been plagued by transmission errors, expensive re-transmission costs, and limited bandwidth capabilities. In the past, the syntax commands for controlling the receivers were transmitted in multiple lines of code. This has proven to be both inefficient and expensive because an error in one line of coding causes the entire transmission to be invalid and, thus, necessitates resending the information. What is needed in the technology is a method that improves the control of receivers by allowing syntax code to be transmitted in a variable length syntax command line.

As disclosed in U.S. Pat. No. 4,985,895 by Pelkey, which is hereby incorporated by reference in its entirety, a microprocessor in each remote receiver assembles and interprets information in the transmitted signals according to a predefined protocol. The protocol enables the transmitter to direct commands to identified sets of remote receivers rather than all of the remote receivers and can switch channels and frequency at will to improve flexibility and security. The protocol defines a special way of packeting asychronously encoded bytes of data so that the remote receiving units may detect packet boundaries, detect one or two bit errors in a packet and correct single bit errors. The remote receivers may also determine if a packet is targeted or addressed to itself and may parse and execute the implied command of the packet. Multiple data fields in each frame contain identification, data and command instructions. With more than a decade of experience in controlling the distribution of media files, Wegener Communications' COMPEL control systems have embodied and proven the success of the Pelkey invention, and the present invention finds its genesis from this robust control system design.

Some prior art satellite systems attempt to provide alternative programming to a select groups of users. For example, U.S. Pat. No. 5,235,643 by Anderson et al. teaches the concept of providing alternative programming, such as delivering targeted advertising to select groups of users. This could occur in situations where some users do not receive certain syndicated features, commonly referred to as blackout occurrences. Anderson, however, does not attempt to mitigate transmission errors by using a variable length command stream.

Other prior art systems attempt to multicast digital data to a user accessing an Internet connection. For example, U.S. Pat. No. 6,101,180 by Donahue et al. discloses sending digital data from a transmission site to a remote location. However, Donahue et al. does not disclose or suggest the concept of transmitting media information by using a variable length command stream. Similarly, other prior art systems attempt to use multicast satellite broadcast technology as a bridge between telephony operations and the Internet. For example, U.S. Pat. No. 6,385,647 by Willis et al. does not disclose or otherwise suggest mitigating transmission errors by using a variable length command stream in the transmission of the information.

### SUMMARY OF THE INVENTION

It is in view of the above problems that the present invention was developed. The invention is a system for controlling a set of receivers in a distributed network. The control system uses a tag-based syntax in which each parameter of a receiver is assigned a unique tag. Each one of the commands that is associated with each of the devices in an integrated receiver/decoder (IRD) has its own unique tag identifier which is formed as a combination of device and command constructs. The parameters can be grouped logically using device values, and the members in the groups can be represented by corresponding command values that are defined in the control system. These device/command tags are used to set the parameters associated with the respective devices in the receivers.

The device/command tag-based syntax allows for setting multiple parameters in a variable length command stream. Using a single, variable length command stream for multiple devices in the receivers can help mitigate transmission errors because all of the data is either dropped together or received together. In the preferred embodiment of the present invention, the representation of the data for each of the parameters is also standardized. Standardization makes the process more streamlined and efficient because a single set of parser routines can be used in the receivers rather than the current method of writing a separate parser for each data buffer. The original set of parser routines that are written for the control codes can be used whenever a new member is incorporated into the receivers, such as the new type of device, without having to write or incorporate into the receiver any new parser routine. This new method of reapplying the original set of parser routines saves time in bringing new devices on-line in the set of receivers and also saves computational time and memory space in the individual receivers.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates a prior art point to multi-point satellite network;

FIG. 2 illustrates a system for controlling a set of receivers;

FIG. 3 illustrates a data portion of a command stream;

FIG. 4 illustrates a device/command construct according to the present invention;

FIG. 5 illustrates an index control code;

FIG. 6 illustrates a data member control code; and

FIG. 7 illustrates a block process diagram for controlling a set of receivers according to the present invention.

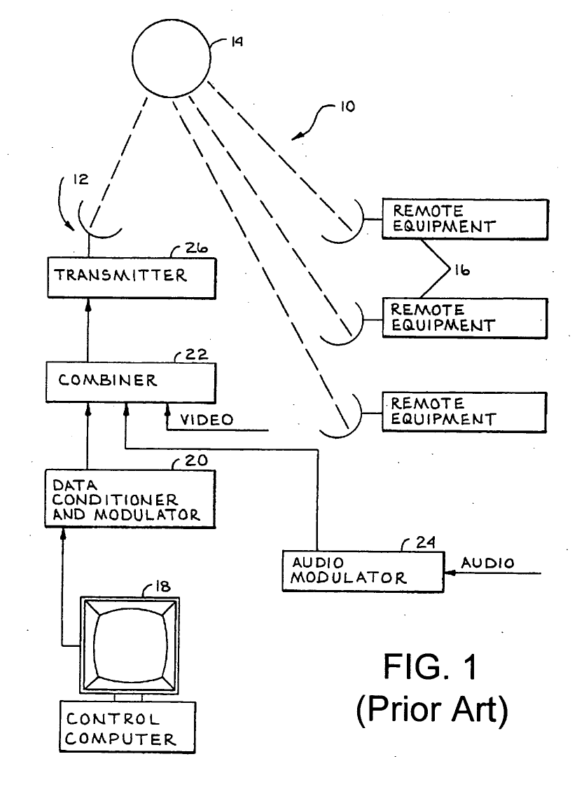

### DETAILED DESCRIPTION OF THE PREFERRED EMBODIMENTS

Referring to the accompanying drawings in which like reference numbers indicate like elements, FIG. 4 illustrates a device/command construct according to the present invention. In particular, the present invention uses a device/command tag syntax in which each command 27A for each device 29A in a receiver 36 is assigned a unique tag identifier 28. The commands 27A for each device 29A correspond with a set of members 27B associated with the respective device 29A (device name 29B). For example, each device in an integrated receiver/decoder (IRD) is associated with a respective set of members, and each one of the members has a corresponding command number (such as the devices NETCON, LOGFILTER and SRCHTBLE and their respective members with corresponding commands which are discussed in detail below). Accordingly, the device/command tag 28, formed as a combination of device 29A and command 27A constructs, uniquely identifies the members for each of the various devices and can generally be referred to as the member identifier 28.

As particularly illustrated in FIG. 4, the parameters (device/member 29B, 27B) of the receivers 36 can be grouped logically according to the device values 29A, and the members 27B in the groups can be represented by corresponding command values 27A defined in the control system. Therefore, the member identifiers 28 (or device/command tags) can be used to control the set of parameters, and multiple parameters can be controlled in a single autonomous command. According to the syntax of the command, the identifier 28 links each parameter to be controlled with a particular control code (i.e., the particular instructions are specifically identified or “addressed” according to the respective member of each device in the receiver that is to be commanded by the instruction).

As an example, the device called “Search Table” (SRCHTBLE) in FIG. 4 could have assigned to it a command called “Command 1” (or “Member_ID 1” in a generic syntax) which could be a carrier frequency (FREQ). Similarly, Member_ID 2 could be defined for a service format function (SRV_FRMT), and Member_ID 3 could be defined for a data rate function (DATARATE). It will be appreciated that additional members 27B and corresponding commands 27A could be added to the SRCHTBLE device. It will also be appreciated that other parameters for the other devices, such as LOGFILTER and NETCON, are individually tagged according to each respective device and its corresponding commands. As another example, the device called “Device 2” could have a series of queries on the status of the receiver 36 or particular devices 29B in the receiver 36, such as the speaker 48, the monitor 50, as well as other devices (MA_ID 1, MA_ID 2, etc.). The device/command tag for each parameter can be generally referred to as an identifier 28 (the member identifier 28) of each parameter member 27 for the devices 29 that are to be controlled (control information) and/or queried (status information) in the set of receivers 36. Accordingly, as discussed below, the data portion of the command stream 140 could contain such an identifier tag 28 for every member, as well as a data type to describe the nature of the parameter.

Before discussing the control codes, including their syntax, operation and the benefits thereof, an example of one type of control system that could implement the present invention is now provided. As discussed in detail below, the control code/parameter identifier 28 link allows the control system to use a standardized structure for control instructions. Parameters are separated in such a manner that the data for that member can be represented as an integer, thereby allowing the same set of parsing routines to be used for most of the member data and improving overall transmission efficiency. Additionally, as discussed below, non-standardized formats and special parsing routines can also be used with the standardized formats and parsing routines of the present invention.

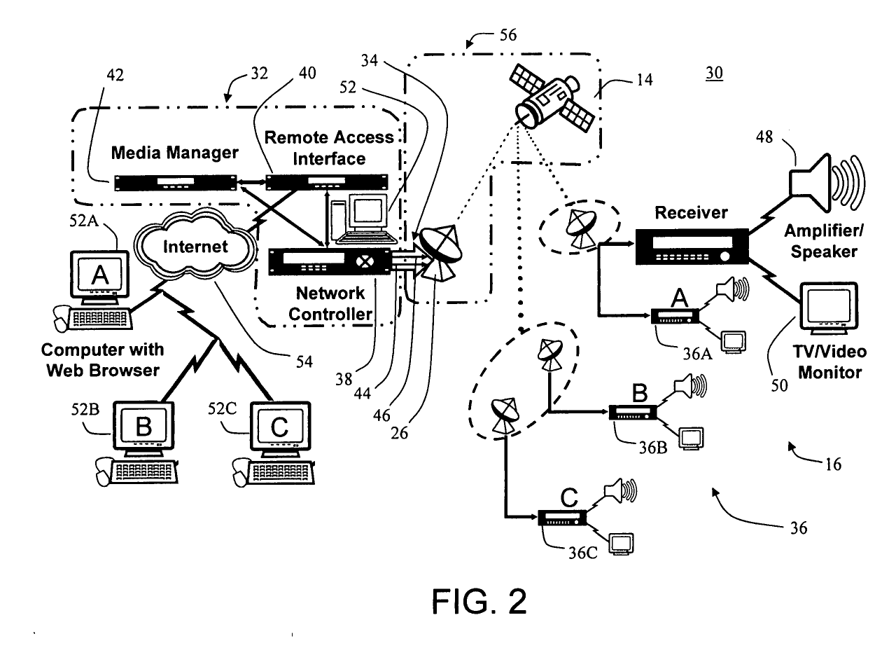

FIG. 2 illustrates a schematic diagram of a computer-based control system 30 that can be used for a number of different distribution and communication applications, a non-exhaustive list of which includes distributing media files to the remote downlink facilities 16, distributing streaming media to the remote downlink facilities 16 (such as audio, video and other multimedia information), distributing classic DVB video to the remote downlink facilities 16, distributing analog video to the remote downlink facilities 16, internet access acceleration/bypass at the remote downlink facilities 16, and database replication at the remote downlink facilities 16. The control system 30 has an uplink server 32 that broadcasts signals 34 over a satellite 14 to one or more sets of remote receivers 36 (36A, 36B, 36C) at the downlink facilities 16. The uplink server 32 preferably includes a network controller 38, an access interface 40 (which may be remote or local) and a media/file/database manager 42. The network controller 38 remotely controls each one of the remote receivers 36 at the downlink facilities 16 by transmitting control instructions 44 to the receivers, preferably in a portion of the broadcast signals 34, with the other portion being used for program content 46. It will be appreciated that the uplink server is illustrated according to its functional parts and although the preferred embodiment has multiple computers, a single computer could perform the functions of the access interface, network controller, and media/file/database manager with an interface circuit 40, a controller circuit 40 and a manager circuit 42, respectively.

The control server 32 is operatively connected to at least one control computer 52, and multiple control computers could be used. The control computer 52 transmits a defined set of control instructions 44 that correspond to a set of commands for the members 27B. The control computer 52 can be an integral part of the control serve 32 and/or control computers 52A, 52B, 52C can be located at a remote location and connected to the control server through a computer network 54. It is envisioned that, as technology advances, the control computer 52 may incorporate most, if not all, of the functions currently embodied in the control server 32. Therefore, although the network controller 38 creates the command stream 140 with the selected members 27B (using the member identifiers 28) and control codes 130 (including control flags 112, 114, 144 and fields 146 along with the commands 27A), the present invention anticipates that a single computer may also perform this control server function as well as the other known control server functions.

The access interface or circuit 40 allows a network operator to access and control the uplink server 32 from the control computer 52, which can be local or can access the interface 40 via a computer network 54. An operator accesses the uplink server 32 through the control computer 52 and interface 40 to select the set of members 27B for the set of receivers 36 to be commanded. The operator also selects at least one command from the set of commands and selects a corresponding set of control codes.

As disclosed in U.S. Pat. No. 4,985,895, each receiver 36 with remote control capabilities can be programmed to store the unique receiver address and group address information that is common to several receivers. Therefore, the control instructions 44 can be used to control a selected group of receivers at multiple downlink facilities 16, from all receivers that receive the broadcast 34 to a particular set of receivers, including a single intended receiver. In addition to defining a set of receivers, the control instructions 44 can configure the receivers and command the selected set of receivers with actions to perform, such as activating the receivers to play out program content 46 over a speaker 48 or a monitor 50. Accordingly, the control instructions 44 are used for controlling each member 27B in the set of devices 29B in a selected set of receivers 36, including any control function initially envisioned by Pelkey, currently implemented in the Wegener Communications' COMPEL control systems, or implemented in future versions of the COMPEL control. For example, in addition to grouping or regrouping the receivers, the control instructions 44 can cause any set or subset of receivers to switch channels, switch frequencies, switch databases, store, organize &/or delete files or database records, start or stop streaming, change audio levels or mute, switch between programs in the broadcast signals, as well as any other control function.

According to the preferred embodiment of the present invention, the unique identifier 28 is assigned to each of the members 27 for the respective devices 29 in each of the receivers 36. Although the preferred embodiment is illustrated with multiple receivers 36 in the set of receivers and multiple devices in each receiver 36, it will be recognized that, under general set theory, the set of receivers and devices may include as few as a single receiver and a single device, respectively.

Additionally, although the device/command construct (i.e., the set of member identifiers 28) is illustrated as in matrix form, the member identifiers 28 could also be illustrated in a single row or in a single column. For example, by merely placing each one of the device names and numbers in front of their respective members and commands, respectively, every member could be listed in a string, e.g., NETCON-LOCK (0x01, 0x06), . . . , LOGFILTER-EVENT_ID (0xC8, 0x01), LOGFILTER-LEVEL (0xC8, 0x02), LOGFILTER-SRC_MSK (0xC8, 0x03), etc. These set theory principles are similarly used throughout the embodiments and benefits of the present invention. As another example, member identifiers are selected from the domain of defined member identifiers 28. The selected set of identifiers 28 can be a single identifier or a group of identifiers, and the domain of defined member identifiers 28 can even be a single identifier, although in the preferred embodiment, the domain has many member identifiers.

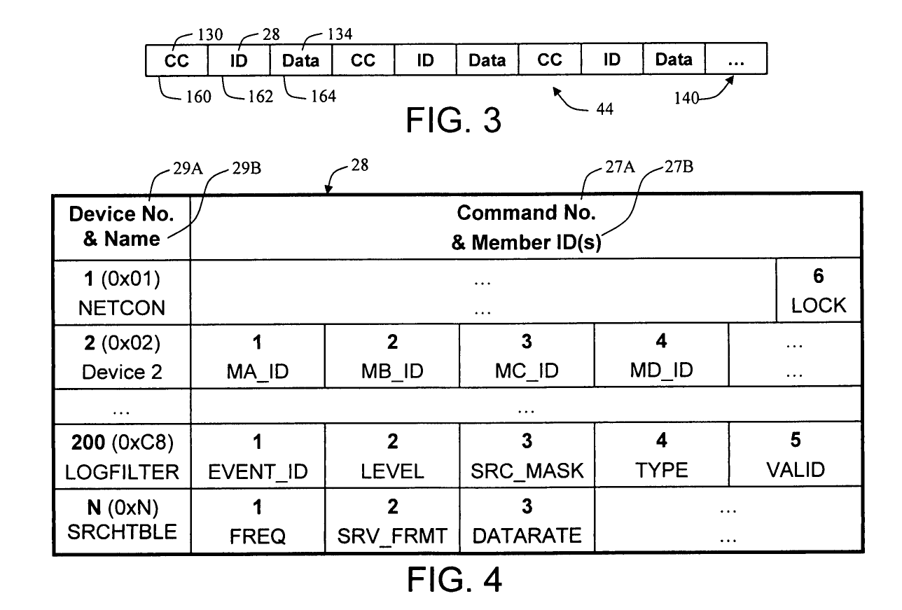

As illustrated in FIG. 3, the control instructions 44 are transmitted in the command stream 140 (integer data is preferably sent most significant bit first) such that a control code 130 precedes the member data 28, including the device number 29B, the command number 27B and any other data 134 that may be used to control the parameter but is not included in the control code logical block 160. Accordingly, the data portion of the command stream 140 is a repeating series of control codes 130 in the first logical block 160 followed by the member identification 28 (i.e., the command number 27A) in the second logical block 162 and that member's parameter data 134 in the third logical block 164.

From the description of the control codes below, it will be appreciated that the logical blocks are not necessarily a single byte of data. For example, the control code logical block 160 could contain multiple bytes, such as for the large buffer data type discussed below. It will also be appreciated that the third logical block 164 is optional because it is not used for certain data_types 146 in the data member control code 120 (discussed in reference to FIG. 6 below). For example, if the data type is a 4-bit integer, the data 134 can be located in the lower bits of the data member control code 120. Generally, the control code 130 contains the data-type information that is used to parse the command stream 140. The control code 130 can be an index control code 110 or a data member control code 120. According to the present invention, the control codes are standardized so that they can be operated on by a common set of standardized parsing routines.

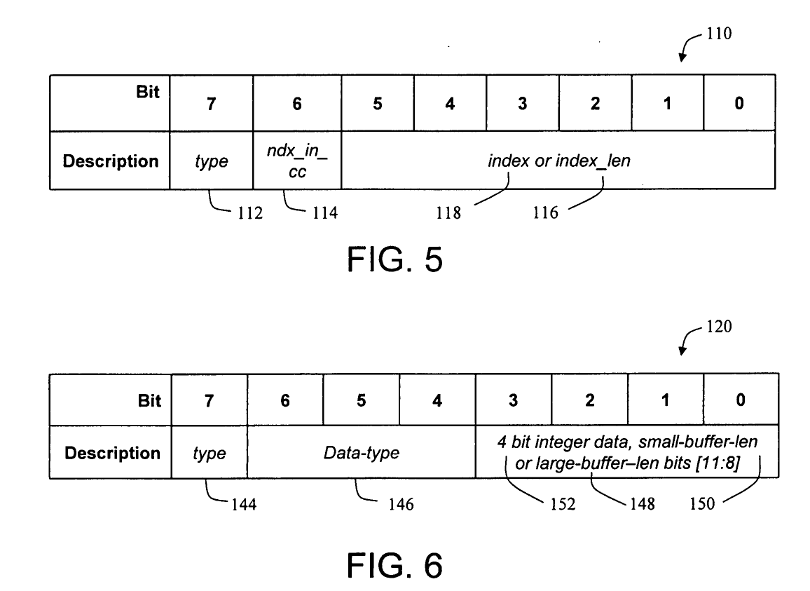

As illustrated by FIG. 5, a single-byte index control code 110 contains index data, including a type flag 112, a ndx_in_cc flag 114, and a field for an index length 116 or an actual index 118. Indexing is used in a number of situations in setting the parameters in a set of receivers 36. For example, indexes can be used for audio port selection and search table selection. The type flag 112 is the leading value in the index control code 110. The type flag 112 indicates the type of the index control code 110. For the index control code 110, the value of the index control code type flag is 1.

The second field or bit in the index control code 110 is the ndx_in_cc flag 114. When the ndx_in_cc flag 114 is set, the index number can be found in the lower part of the control code 130. This applies if the index value would fit into the lower six bits of the index control code byte 110. Thus, a value of “11111” in binary format, or 63 in decimal format, fits in the six bits, whereas the value of “1000000” in binary format, or 64 in decimal format, would be too large to fit into the lower six bits of the first byte of the index control code 130.

If the ndx_in_cc flag 114 is set to 0, the index 118 immediately follows the control code and its size is defined by examining an index_len field 116. As shown in FIG. 5, the rightmost field will contain either the index_len field 116 or the index 118. The index_len field 116 specifies the length of the index 118. Table 1 below correlates index_len 116 values in the index control code 110 with particular index lengths.

TABLE 1
Index_Len Values

| Index_Len Value | Index Length |
|---|---|
| 0 | 1-byte integer |
| 1 | 2-byte integer |
| 2 | 4-byte integer |
| 3 | Reserved |

According, the index 118 is identified by sending the index control code byte 110 followed by the optional index value. The index value's size is determined by examining the index control code 110. The fields in the index control code 110 are either a 0 or a 1 because the index control code is binary in nature. In examining the index field 118, it will be appreciated that the lower bits of the index control code 110 can contain the index if the value is less than 64 in decimal format, i.e. “1000000” in binary format. The index field 118 is valid when the ndx_in_cc field is set to 1.

As illustrated by FIG. 6, single-byte data member control code 120 contains a type flag 144, a data_type field for a large_buffer_len 148, a small_buffer_len 150 or a 4-bit integer 152. The type flag 144 indicates the type of the data member control code 120. The type flag 144 value is 0 for data control code. The data_type field 146 specifies the length of the data 134 that follows. Table 2 correlates the data_type field 146 values in the data member control code 120 with particular data lengths.

TABLE 2
Data_Type Field Values

| Data_Type Value | Data Length |
|---|---|
| 0 | 1-byte integer |
| 1 | 2-byte integer |
| 2 | 4-byte integer |
| 3 | Small buffer |
| 4 | Large buffer |
| 5 | Reserved |
| 6 | Reserved |
| 7 | 4-bit integer |

When the value of the data_type field 146 is four (large_buffer_len 148), the byte immediately following the control code contains bits “[7:0]” of the large buffer and the lower four bits of the data member control code 120 contain bits “[11:8]” of the large buffer. In comparison, when the value of the data_type field 146 is three (small_buffer_len 150), the lower four bits of the data member conrol code 120 are the buffer length. When the value of the data_type field 146 is seven (4-bit integer 152), the lower four bits of the data member control code 120 contain the data 134 for this member. The 4-bit integer 152 is useful for Boolean data types because one byte is used to hold the data-type information 146 and the data 134.

Generally, to command a parameter (i.e. a member of any device in the receiver), the command stream 140 contains a control code 130, the member identifier 28, and data 134. As discussed above, the control code 130 describes the type of data 134 being sent. The member identifier 28 can be the command value in the command stream 140 when one parameter is being set at a time. Alternatively, the member identifier 28 can be found in the data portion of the command stream 140 when commanding multiple parameters that are grouped in the same command stream 140. When commanding one parameter at a time, the data 134 for this parameter follows the control code 130. Therefore, for the case where the data type is a “large buffer,” the control code 130 has a total length of 2-bytes. Accordingly, in the preferred embodiment of the present invention, the command stream is built with variable-length logic blocks 160, 164 (i.e. a variable-length command stream), such as discussed above for the control code 130 and the member data 134. The variable-length logic blocks improve the overall efficiency of transmitting the control instructions 44 by the system 30.

Commands 27A can be grouped to command multiple parameters for a given device 29B in near-simultaneous manner. Accordingly, the parameter data (i.e. the commands 27A in the control code 130 and the data 134) for multiple members 27B of a device can be sent in a single command stream 140. The single grouped command stream 140 also helps to mitigate transmission errors because all of the data is either dropped together or received together. This is a very beneficial feature of the present invention because it will improve the overall transmission efficiency. In the past, commands were written on several lines of code. This process, unfortunately, caused numerous transmission shutdowns and resulted in information needing to be resent. Errors in subsequent lines of code caused prior lines of code to be invalid and thus necessitated resending of all lines of code in order to complete a transmission.

Grouped commands can contain multiple constructs of the control code-member identifier-member data (i.e., logic block command constructs 160, 162, 164) in the command stream 140, as illustrated in FIG. 3. Preferably, there is no dependency on the order of the transmitted parameters and the receiver operates on the parameters after the entire command stream 140 is received and processed. Therefore, the interdependencies of the data can be resolved mostly at execution time, not when each parameter is received. For the index value, the preferred embodiment resolves interdependencies at the time it is received.

In the preferred embodiment, grouping is identified by setting the command entry in the command stream 140 to a value of 255 in decimal form, i.e., 0xFF in hexadecimal form or 11111111 in binary form. The “255-command” causes the receiver's parsing function to parse each of the logic block command constructs 160, 162, 164 (control code-member identifier-member data 130, 28, 34) in the data portion of the command stream 140. The set of standardized parser routines are preferably incorporated into the receivers 36 to parse the variable-length command stream 140 into a plurality of commands and the corresponding control codes according to the standardized constructs for the data described above.

There are several benefits to the standardized format of the command stream 140 according to the present invention. The standardization makes the process more streamlined and efficient because a standardized set of parser routines can be used in the receivers rather than the current method of writing a separate parser for each data buffer. According to the present invention, the original set of parser routines that are written for the control codes 130 can be used whenever a new device 29 is incorporated into the receivers 36 or whenever a new member 27A/command 27B is added to an existing device 29A, i.e. without having to write or incorporate into the receiver any new parser routine. This new method of reapplying the original set of parser routines not only saves time in bringing new devices on-line in the receivers, but it also saves computational time and memory space in the receivers.

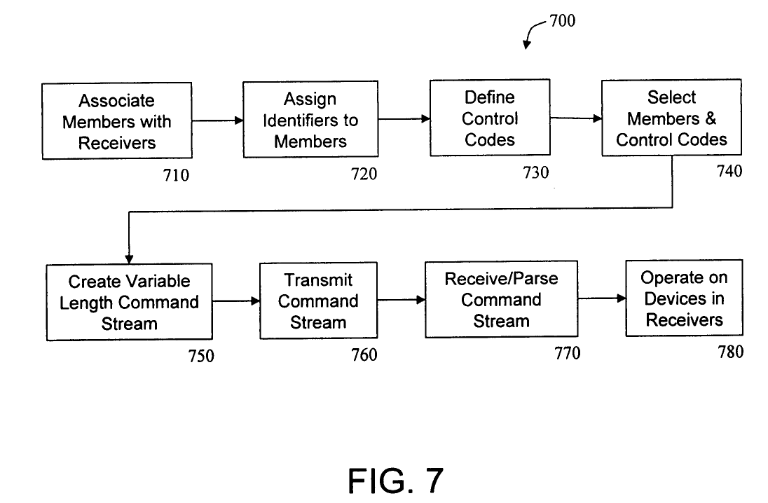

The operation 700 of the present invention is illustrated by the block process diagram in FIG. 7 and is described in detail below with reference to the elements in the control system 30 which perform the steps in the process, such as the control server 32, including the network controller or circuit 38 and the access interface or circuit 40, the control computer 52, and the set of receivers 36. As discussed above with reference to FIG. 2, it will be appreciated that a single computer may perform the functions of the control server 32. Therefore, the functional aspects of the elements in the control system 30 may be interchanged, combined or distributed amongst the existing devices in the preferred embodiment of the control system 30 or even new devices that may be added to the control system 30 in the future.

The control server 32 associates the set of members 27B with the set of receivers 36 (710). In particular, the control server 32 associates the set of members 27B with the set of devices 29B that are in the set of receivers 36 and assigns the set of unique identifiers 28 to the corresponding set of members 27B (720). A set of control codes 130 are defined; the control codes 130 correspond with the commands 27A for the set of members 27B, and the control computer 52 communicates the defined set of control codes 130 to the control server 32 (730). The control server's access interface 40 is in communication with the control computer 52, and an operator uses the control computer 52 to select a set of members 27B for the set of receivers 36 to be commanded and to select a set of corresponding control codes from the set of control codes 130 (740). The network controller 38 creates the command stream 140 with the selected set of members 28 and the selected set of corresponding control codes 130 (750). The transmitter 26 sends the command stream 140 to the set of receivers 36(760).

According to the preferred embodiment of the invention, the command stream 140 is transmitted to the receivers 36 over a satellite 14 or a network of transmitters and satellites 56. The command stream 140 is received and parsed by the selected set of receivers 36 (770). As discussed above, there is no dependency on the order of the transmitted parameters and the receivers 36 operate on the respective devices 29B after the entire command stream 140 is received and processed (780). Therefore, the interdependencies of the data can be primarily resolved at the time of execution, not when each parameter is received.

It will be appreciated that, according to the present invention, the set of members 27B are selected using the member identifiers 28 described above. It will also be appreciated that, as discussed above, the control codes 130 also contain other information in addition to the commands 27A. For example, the control codes 130 also contain the type flag 112, 144 and the index control codes 110 contain the ndx_in_cc flag 114 and the command data control codes contain the data_type field 146. Additionally, as discussed above, the command stream 140 is preferably constructed using variable length logic blocks 160, 162, 164 and is preferably a single autonomous command stream, although the command stream can be formed from logic blocks having a specified length or from multiple stream segments without detracting from the benefits of the invention. Similarly, the invention is not limited to satellite systems as it could also be used with any sort of terrestrial-based system. Likewise, non-standardized commands may be transmitted with the non-standardized command having a uniquely associated buffer and parsing the non-standardized command.

For example, the MCPC TUNE command can be retained as a non-standard command in combination with the standardized format of the present invention. Assume that in prior art control systems for media distribution, the MCPC TUNE command already exists. The device number is 38, and the command number is 1. However, according to the prior art non-standardized system, this command has a special non-standard buffer associated with it for transmitting the data to the receivers (first 3 bytes are carrier frequency, the next byte is service format, the next 3 bytes contain data rate,. etc.), and a developer uses the prior art control system's interface control documentation (ICD) to write an algorithm to parse the non-standard buffer format. It will be appreciated that this non-standard format can be replaced by the new standardized format of the present invention. For example, the parameters for the SRCHTBLE device, discussed above, are in the standard format of the present invention and contain the same commands as the MCPC TUNE command. However, inasmuch as the MCPC TUNE command already exists and its parser routine is already in the receivers 36 at the remote sites 16, the command can alternatively be retained in its current format (i.e., the legacy format), and the receivers 36 can support the legacy format for existing devices.

The present invention is further disclosed below by way of more examples, which correspond with the device/command tags 28 illustrated in FIG. 4: The first example below for the NETCON device is simple and does not require grouping of the commands. In comparison, the second example for the LOGFILTER device is more complex and particularly illustrates the concept of grouping with indexing.

### EXAMPLE 1

For the first example, the techniques and processes described above are used to create a serial stream for the NETCON device using the LOCK/UNLOCK command. The device number for NETCON can be defined as 1 (0x01), and the command number for the LOCK parameter can be defined as 6 (0x06). The parameter type for LOCK can be Boolean, i.e., “1” for locked and “0” for unlocked. Following the instructions below, the control system can “lock” the control state of the receiver.
1. The command buffer is filled with the device and command. Since we are just going to set one parameter (the lock state of the control in the IRD), grouping does not have to be used and we can use the LOCK member id for the command.
   Buffer after Step 1: (0x00, 0x01, 0x06).
2. The control code is inserted next. This is a data control code, so the type is 0. Since the value of this command can be fit into 4 bits, the value will be put in the control code using a data_type of 7.
   Buffer after Step 2: (0x00, 0x01, 0x06, 0x71).

### EXAMPLE 2

For the second example, the techniques and processes described above are used to set and clear the Log Filter device in a set of receivers. The device number for the LOGFILTER is 200 (0xC8), and the command numbers for several parameters associated with the Log Filter device are set forth in Table 3 below (as well as in FIG. 4).

TABLE 3
LOGFILTER Commands

| Command | |
|---|---|
| No. | Member ID |
| 1 | EVENT_ID: ID of the event the filter parameters will apply |
| | too |
| 2 | LEVEL: All events less than or equal to this level will |
| | be logged (with the exception of the OFF level). The |
| | levels are 0 = OFF, 1 = ALARM, 2 = WARNING, |
| | 3 = BASIC, 4 = DETAILED, and 5 = DEBUG. |
| 3 | SOURCE_MASK: This is a bit-mask used to |
| | indicate which event sources will be logged for the ID given. |
| 4 | TYPE: This is the type of filter. 0 = store filter, 1 = read filter |
| 5 | VALID: Boolean value to indicate if this particular filter is |
| | valid. |

In the preferred embodiment, each receiver 36 can have up to fifty (50) filters that can be assigned from the command. The index 118 will be the number in the table of fifty filters that the control system 30 is going to SET or CLEAR. Since, for the most part, it makes more sense to set one particular filter in its entirety, all data members are grouped together using the grouping method described above. The following steps show how to build a command buffer to SET Log Filter index number 5 to Event_ID 2048, Level of BASIC, Source Mask of ALL (0xFFFF), Type of Store, and Valid equal to TRUE.
1. The command buffer is filled with the device (200 in decimal=0xC8 in hexadecimal=11001000 in binary) and command. The filter will be SET using the grouping method so the command number 255 is used.
   Buffer after Step 1: (0x00, 0xC8, 0xFF).
2. The index 118 is inserted first in the stream data portion. First the index control code 110 is inserted. The control code type is 1 for an index (10000000), and since the index number can be represented in the lower part of the control code (5 in decimal=00000101 in binary), the ndx_in_cc bit 114 is set to 1 (01000000). Therefore, only a single byte is used for this index, 1100010 1 in binary (0xC5 in hexadecimal).
   Buffer after Step 2: (0x00, 0xC8, 0xFF, 0xC5).
3. All of the data members can now be added. First the ID is added. The ID will take 2 bytes so the data_type 146 in the control code is set to 1. The control code 130 becomes 0x10. The member ID 28 (command value) follows and is 0x01. Then the data follows (most significant bit first) 0x08, 0x00. The entire value for the ID member is (0x10, 0x01, 0x08, 0x00).
   Buffer after Step 3: (0x00, 0xC8, 0xFF, 0xC5, 0x10, 0x01, 0x08, 0x00)
4 Next the LEVEL value is added. The value can fit in 4 bits, so it is put in the control code 130 and the corresponding data_type 146 is set. The control code 130 becomes 0x73. The member ID 28 (command value) follows and is 0x02. The entire value for the LEVEL member is (0x73, 0x02).
   Buffer after Step 4: (0x00, 0xC8, 0xFF, 0xC5, 0x10, 0x01, 0x08, 0x00, 0x73, 0x02)
5. Now the rest of the members can be added “0x10, 0x03, 0xFF, 0xFF” for SOURCE_MASK, “0x70, 0x04” for TYPE, and “0x71, 0x05” for VALID. It should be appreciated that the individual parameters can be in any order.
   Buffer after Step 5: (0x00, 0xC8, 0xFF, 0xC5, 0x10, 0x01, 0x08, 0x00, 0x73, 0x02, 0x10, 0x03, 0xFF, 0xFF, 0x70, 0x04, 0x71, 0x05).

To CLEAR filter number 5, a simple one member change command could be used. The buffer would be “0x00, 0xC8, 0x05, 0xC5, 0x70”. Byte 0 and 1 is the device and byte 2 is command, i.e., the device/command tag (member identifier 28), byte 3 is the index, and byte 4 is the data value. Note that one byte is used for the index and the data control code value.

Given the examples above, it will be appreciated that the members 27B can be a set of control members (NETCON—LOCKIUNLOCK, LOGFILTER, etc.), a set of status information members (Device 2—MA_ID 1, Device 2—MA_ID 2, Device 2—MA_ID 3, etc.), or a combination of the set of control and status information members. It will also be appreciated that the identifiers 28 and corresponding control codes 130 (and optional data 134) are grouped for the selected set of members 27B in a single autonomous variable length command stream 140. The command stream 140 can include non-related parameters as exemplified above. Additionally, other non-related parameters that can be commanded in a single command stream 140 include the program number and media language descriptor, which can be audio, visual, or audio and visual. Accordingly, the present invention can be applied in any type of system that controls the distribution of transmitted media information as well as any other type of communication application in which distributed set receivers are being controlled by a command stream.

As described and exemplified above, the present invention defines a control system 30 that uses a tag-based syntax 28 in which each parameter (device/member 29B, 27B) of a receiver 36 is assigned a unique tag (device number/command number 29A, 27A). Therefore, each command 27A that is associated with a respective device 29A in the IRD 36 can have its own unique tag identifier 28 formed as a combination of the device 29A and command 27A constructs. The parameters can be grouped logically using the device values 29A, and the members 27B in the groups can be represented by corresponding command values 27A that are defined in the control system 30. Accordingly, these device/command tags 28 are used in combination with corresponding control codes 130 in the command stream 140 to set the parameters associated with the respective devices 29B in the receivers 36.

The device/command tag-based syntax allows for setting multiple parameters in a variable length command stream 140. Using a single, variable length command stream 140 for multiple devices in the receivers 36 can help mitigate transmission errors because all of the data is either dropped together or received together. This “all or nothing” approach for the command stream actually improves the overall transmission efficiency over prior art systems in which commands were written on several lines of code. In these prior art systems, the failure of a single line of code could propagate yet more errors in the system of receivers. For example, even if other lines of code for other devices were received without error, the failure of the line of code for another device could cause the commands to the other devices to fail, especially if one of the devices is dependent on the proper operation of the device with the erroneous command. Therefore, in prior art systems, a single command error could cause numerous transmission shutdowns and would likely require all of the information to be resent. Errors in subsequent lines of code could even cause prior lines of code to be invalid, thereby necessitating another transmission with all of the code in order to complete a valid transmission.

In the preferred embodiment of the present invention, the representation of the data for each of the parameters is also standardized. Standardization makes the process more streamlined and efficient because a single set of parser routines can be used in the receivers rather than the current method of writing a separate parser for each data buffer. Using the prior art parsing techniques and processes, each new data buffer for a new member (such as a new type of device in the receivers or a new command for an existing device) would have required yet another parser routine. In comparison, according to the present invention, the original set of parser routines that are written for the command stream 140 can be used whenever a new member is incorporated into the receivers without having to write or incorporate into the receiver any new parser routine. This new method of reapplying the original set of parser routines not only saves time in bringing new devices on-line in the receivers, but it also saves computational time and memory space in the receivers.

In view of the foregoing, it will be seen that the several advantages of the invention are achieved and attained. The embodiments were chosen and described in order to best explain the principles of the invention and its practical application to thereby enable others skilled in the art to best utilize the invention in various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. For example, the control system 30 may be remotely controlled, as disclosed in U.S. application Ser. No. 10/641,187, filed Aug. 14, 2003, which is hereby incorporated by reference in its entirety. Thus, the breadth and scope of the present invention is not limited by the above-described exemplary embodiments, but is defined only in accordance with the following claims appended hereto and their equivalents.

1. A method for controlling a set of receivers, comprising the steps of:
associating a set of members with each receiver in the set of receivers;
assigning a unique identifier to each member in said set of members;
defining a set of control codes corresponding to a set of commands for said members;
selecting a set of members for the set of receivers to be commanded using said unique identifier for each member in said selected set of members and selecting a corresponding set of control codes for each member in said selected set of members;
creating a variable length command stream with said selected set of members and said corresponding set of control codes; and
transmitting said variable length command stream to the set of receivers.

2. The method according to claim 1 wherein said associating step is further comprised of associating said set of members with a set of devices in the set of receivers, and wherein said assigning step is further comprised of assigning a device tag identifier to each device in said set of devices and a corresponding command tag identifier to each member respectively associated with each device in said set of devices.

3. The method according to claim 1 wherein said selecting step is further comprised of selecting a set of said unique identifiers associated with said selected set of members, and wherein said members are selected from the group consisting of control members, status information members, and a set of control and status information members.

4. The method according to claim 3 wherein said set of unique identifies is selected from a set of integers.

5. The method according to claim 1 wherein said creating step further comprises the step of grouping a plurality of commands and said corresponding control codes for said selected set of members in a single autonomous variable length command stream, and wherein said plurality of commands and corresponding control codes further comprise non-related parameters.

6. The method according to claim 1 wherein said set of control codes is selected from the group consisting of index data and member data.

7. The method according to claim 1, further comprising the step of incorporating a single set of parser routines in the receivers to parse said variable length command stream into a plurality of commands and said corresponding control codes for said selected set of members according to a single standardized data type.

8. The method according to claim 7, further comprising the steps of incorporating at least one non-standardized parser routine in at least one receiver, transmitting a non-standardized command having a uniquely associated buffer, and parsing said non-standardized command.

9. The method according to claim 1 wherein said variable length command stream is transmitted to the set of receivers over a satellite network.

10. The method according to claim 1 wherein the step of creating said variable length command further comprises the steps of:
inserting one of the plurality of control codes in a first logical block;
inserting a member identification into a second logical block; and
inserting one of multiple parameters in a third logical block.

11. A method for controlling a set of receivers, comprising the steps of:
associating a set of members with each receiver in the set of receivers;
assigning a plurality of unique identifiers respectively to members in said set of members;
defining a set of control codes corresponding to a set of commands for said members;
selecting a plurality of members for the set of receivers to be commanded using said plurality of unique identifiers for said respective members and selecting a plurality of corresponding control codes for said selected plurality of members;
creating a command stream with said selected members and said plurality of corresponding control codes; and
incorporating a set of parser routines in the receivers to parse said command stream into a plurality of members and said corresponding control codes, wherein said set of parser routines operates on said command stream according to a single standardized data type; and
transmitting said command stream to the set of receivers.

12. The method according to claim 11 wherein said associating step is further comprised of respectively associating each of said members with a plurality of devices in the set of receivers, and wherein said assigning step is further comprised of assigning a unique device tag identifier to each of said devices and a corresponding command tag identifier to each of said members respectively associated with said devices, and wherein said selecting step is further comprised of selecting a plurality of unique identifiers associated with said plurality of members.

13. The method according to claim 11 wherein said creating step further comprises the step of grouping said commands and said corresponding control codes for said selected members in a single autonomous command stream, and wherein said plurality of commands and corresponding control codes further comprise non-related parameters.

14. The method according to claim 13 wherein said command stream is variable length.

15. The method according to claim 11 wherein said control codes is selected from the group consisting of index data and member data.

16. The method according to claim 11 wherein said incorporating step is further comprised of the steps of incorporating at least one non-standardized parser routine in at least one of said receivers, transmitting a non-standardized command having a uniquely associated buffer, and parsing said non-standardized command.

17. The method of claim 11 wherein said command stream is transmitted to the set of receivers over a satellite network.

18. A method for controlling a set of receivers, comprising the steps of:
associating a set of members with each receiver in the set of receivers;
assigning a plurality of unique identifiers respectively to members in said set of members;
defining a set of control codes corresponding to a set of commands for said members;
selecting a plurality of members for the set of receivers to be commanded using said plurality of unique identifiers for said respective members and selecting a plurality of corresponding control codes for said selected plurality of members;
creating a single autonomous command stream with said selected members and said plurality of corresponding control codes, wherein said plurality of commands and corresponding control codes further comprise non-related parameters; and
transmitting said command stream to the set of receivers.

19. The method according to claim 18 wherein said associating step is further comprised of respectively associating each of said members with a plurality of devices in the set of receivers, and wherein said assigning step is further comprised of assigning a unique device tag identifier to each of said devices and a corresponding command tag identifier to each of said members respectively associated with said devices, and wherein said selecting step is further comprised of selecting a plurality of unique identifiers associated with said plurality of members.

20. The method according to claim 18 wherein said command stream is variable length.

21. The method according to claim 18 further comprising the steps of incorporating at least one non-standardized parser routine in at least one of said receivers and incorporating a set of parser routines in the receivers to parse said command stream into a set of commands and said corresponding set of control codes for said selected set of members according to a single standardized data type.

22. A system for controlling a set of receivers, comprising:
a control server having a plurality of members associated with each receiver in the set of receivers and having a unique identifier assigned to each member in said plurality of members,
control computer operatively connected to said control server, wherein said control computer communicates to said control server a defined plurality of control codes corresponding to a plurality of commands for said plurality of members;
an interface circuit in communication with said control computer through which a set of members is selected from said plurality of members for the set of receivers to be commanded and through which a corresponding set of control codes are selected from said plurality of control codes, wherein each member in said selected set of members further comprises said corresponding assigned unique identifier;
a network controller in communication with at least one of said interface circuit and said control computer for creating a command stream with said selected set of members and said selected corresponding set of control codes;
a transmitter for sending said command stream to the set of receivers.

23. The system according to claim 22 wherein said interface circuit further comprises a means for selecting a set of said unique identifiers associated with said selected set of members.

24. The system according to claim 22 wherein each receiver in the set of receivers comprises a plurality of devices associated with said plurality of members, and wherein each device further comprises a unique device tag identifier and each member further comprises a corresponding command tag identifier.

25. The system according to claim 22 wherein said control server further comprises a means for grouping a plurality of commands and a plurality of corresponding control codes for said selected set of members into a single autonomous variable length command stream, wherein said commands and corresponding control codes further comprise non-related parameters.

26. The system according to claim 22, further comprising a means for incorporating a single set of parser routines in the set of receivers to parse said command stream into a set of commands and said corresponding control codes for said set of members according to a single standardized data type and a means for incorporating at least one non-standardized parser routine in at least one of the receivers.

27. The system according to claim 22, wherein said command stream further comprises a first logical block containing said set of control codes and a second logical block containing a member identification, with said second logical block following said first logical block.

28. A system for controlling a set of receivers, comprising:
a means for associating a plurality of members with each receiver in the set of receivers;
a means for assigning a unique identifier to each member in said plurality of members,
a means for defining a set of control codes respectively corresponding to a plurality of commands for said plurality of members;
a means for selecting a set of members from said plurality of members for the set of receivers to be commanded;
a means for selecting a set of control codes from said set of control codes, wherein said selected set of control codes respectively correspond to said selected set of members;
a means for creating a command stream with said selected set of members and said selected set of control codes;
a means for sending said command stream to the set of receivers.

29. The system according to claim 28, wherein said associating means, said assigning means, said selecting means, and said creating means are selected from a group of control means consisting of a control server, a control computer, and a control computer in communication with a control server, and wherein said sending means is a transmitter.

30. The system according to claim 29, wherein said control server further comprises a controller circuit, an interface circuit, and a manager circuit.

31. The system according to claim 30, wherein said interface circuit functions as said means for selecting said set of members and as said means for selecting said set of control codes.

32. The system according to claim 27, further comprising a means for grouping said selected set of commands and said selected set of control codes into a single autonomous variable length command stream.

33. The system according to claim 27, further comprising a means for incorporating a single set of parser routines in the set of receivers to parse said command stream according to a single standardized data type and a means for incorporating at least one non-standardized parser routine in at least one of the receivers.
